(19) United States
(12) Patent Application Publication
(10) Pub. No.: US 2026/0089346 A1
(43) Pub. Date: Mar. 26, 2026

(54) DEVICE AND METHOD FOR VIDEO DECODING

(71) Applicant: AMLOGIC (SHANGHAI) CO., LTD., Shanghai (CN)

(72) Inventor: Yuyu Yan, Shanghai (CN)

(21) Appl. No.: 19/336,248

(22) Filed: Sep. 22, 2025

(30) Foreign Application Priority Data
Sep. 24, 2024 (CN) 202411338567.X

(51) Int. Cl. H04N 19/593; H04N 19/124; H04N 19/44

(52) U.S. Cl. CPC H04N 19/593; H04N 19/124; H04N 19/44

(57) ABSTRACT

A device and method for video decoding, wherein in the device for video decoding, an inverse transform circuit and an inverse quantization circuit cyclically share a data storage circuit, thereby eliminating the need to provide an additional storage circuit for the inverse transform circuit specifically for storing predicted residual coefficients for pixel positions in a current transform block to be processed, thereby saving the area of the device for video decoding.

### CROSS-REFERENCE TO RELATED APPLICATIONS

This application claims priority to Chinese Patent Application No. 202411338567.X, filed on Sep. 24, 2024, the entire disclosure of which is incorporated herein by reference.

### TECHNICAL FIELD

The present disclosure relates to the technical field of image processing, and in particular to a device and method for video decoding.

### BACKGROUND

Versatile Video Coding (VVC) is a state-of-the-art video coding standard designed to improve video compression efficiency, reduce bandwidth requirements, and maintain high-quality video transmission. Inverse transform coding is a key step in VVC. It is performed after entropy decoding to restore the quantized coefficients of the probability distribution to the original discrete cosine transform (DCT) coefficients, thereby reconstructing the video image.

The block-based delta pulse code modulation (BDPCM) mode is a block-level intra-frame prediction mode for screen content incorporated into VVC video coding. Accordingly, in VVC video coding, when performing the inverse BDPCM transform on the prediction residual coefficients for each pixel position in the transform block to be processed, the prediction residual coefficients for all pixels above or to the left of the transform block are required.

Since the prediction residual coefficients for the pixel positions in the transform block parsed from the code stream are not in a linear order vertically or horizontally, a storage circuit that can accommodate at least the prediction residual coefficients for all pixel positions in the transform block needs to be added before performing the inverse quantization operation, resulting in an increase in the area of the device for video decoding.

### SUMMARY

The problem solved by the embodiments of the present disclosure is to provide a device and method for video decoding, which can save the area of the device for video decoding.

To solve the above problem, a device for video decoding is provided in the embodiments of the present disclosure, comprising:
a data storage circuit, comprising a plurality of memory cells corresponding one-to-one to pixel positions in a current transform block, configured to store prediction residual coefficients for pixel positions in the current transform block, read the stored prediction residual coefficients and send them to an inverse transform circuit; and further configured to receive inverse quantization results for pixel positions in the current transform block from an inverse quantization circuit and write the results into the memory cells;
the inverse transform circuit, configured to perform inverse transform processing on the prediction residual coefficients sent by the data storage circuit to obtain corresponding inverse transform results;
the inverse quantization circuit, configured to perform inverse quantization processing on the inverse transform results sent by the inverse transform circuit to obtain corresponding inverse quantization results.

Optionally, the data storage circuit comprises a single-port memory or a dual-port memory.

Optionally, if the data storage circuit comprises the single-port memory, further comprises:
a gating control circuit, configured to receive an access request from the inverse transform circuit and an access request from the inverse quantization circuit, generate a gating control signal having a first logic level upon receiving the access request from the inverse transform circuit, and generate a gating control signal having a second logic level upon receiving the access request from the inverse quantization circuit;
a data gating circuit, configured to couple the inverse transform circuit to the data storage circuit upon receiving the gating control signal having the first logic level and couple the inverse quantization circuit to the data storage circuit upon receiving the gating control signal having the second logic level.

Optionally, the gating control circuit is further configured to generate the gating control signal having a second logic level upon simultaneously receiving the access request from the inverse transform circuit and the access request from the inverse quantization circuit, thereby causing the data gating circuit to couple the inverse quantization circuit to the data storage circuit.

Optionally, the first logic level comprises a logic high level and the second logic level comprises a logic low level.

Optionally, the data gating circuit comprises a multiplexer.

Optionally, the inverse transform circuit is configured to perform inverse transform processing on the received prediction residual coefficients for the pixel positions in the current transform block using a horizontal mode.

Optionally, the inverse transform circuit is configured to perform inverse transform processing on the received prediction residual coefficients for the pixel positions in the current transform block using a longitudinal mode.

Optionally, the inverse transform circuit is configured to perform inverse BDPCM transform processing on the received prediction residual coefficients to obtain inverse BDPCM transform results for the pixel positions in the current transform block; and
the inverse quantization circuit is configured to receive the inverse BDPCM transform results for the pixel positions in the current transform block; and perform inverse quantization processing on the received inverse BDPCM transform results for the pixel positions in the current transform block to obtain inverse quantization results for the pixel positions in the current transform block.

Optionally, the data storage circuit comprises an SRAM memory.

Correspondingly, a method for video decoding is further provided in the embodiments of the present disclosure, comprising:
using a data storage circuit to store prediction residual coefficients for pixel positions in a current transform block, the data storage circuit comprising a plurality of memory cells corresponding one-to-one to the pixel positions in the current transform block;
using the data storage circuit to read the stored prediction residual coefficients and send them to an inverse transform circuit;
using the inverse transform circuit to perform inverse transform processing on the prediction residual coefficients sent by the data storage circuit to obtain corresponding inverse transform results;
using an inverse quantization circuit to perform inverse quantization processing on the inverse transform results sent by the inverse transform circuit to obtain corresponding inverse quantization results;
using the data storage circuit to write the inverse quantization results sent by the inverse quantization circuit into the memory cells.

Compared with the prior art, the technical solutions in the embodiments of the present disclosure have the advantages as follows:

The device for video decoding provided in the embodiments of the present disclosure comprises: a data storage circuit, comprising a plurality of memory cells corresponding one-to-one to pixel positions in a current transform block, configured to store prediction residual coefficients for pixel positions in the current transform block, read the stored prediction residual coefficients and send them to an inverse transform circuit; and further configured to receive inverse quantization results for pixel positions in the current transform block from an inverse quantization circuit and write the results into the memory cells; the inverse transform circuit, configured to perform inverse transform processing on the prediction residual coefficients sent by the data storage circuit to obtain corresponding inverse transform results; the inverse quantization circuit, configured to perform inverse quantization processing on the inverse transform results sent by the inverse transform circuit to obtain corresponding inverse quantization results.

In the device for video decoding provided in the embodiments of the present disclosure, the inverse transform circuit and the inverse quantization circuit cyclically share the data storage circuit, and there is no need to additionally set up a storage circuit for the inverse transform circuit specifically for storing the predicted residual coefficients for the pixel positions in the current transform block to be processed. Therefore, the storage area of the data storage circuit can be saved, which is beneficial to saving the occupied area of the device for video decoding.

### BRIEF DESCRIPTION OF THE DRAWINGS

FIG. 1 shows a schematic structural diagram of an embodiment of the device for video decoding according to the present disclosure;

FIG. 2 shows a schematic diagram of the storage location of the prediction residual coefficients for the pixel positions in the current 8×8 transform block in the 8×8 data storage circuit;

FIG. 3 shows a schematic diagram of an embodiment of the read, write, and generation order of relevant data in the device for video decoding according to the present disclosure;

FIG. 4 shows a schematic diagram of another embodiment of the read, write, and generation order of relevant data in the device for video decoding according to the present disclosure.

### DETAILED DESCRIPTION

As can be seen from the background, current devices for video decoding have a problem of being too large in area.

In order to solve the technical problem, the device for video decoding provided in the embodiments of the present disclosure comprises: a data storage circuit, comprising a plurality of memory cells corresponding one-to-one to pixel positions in a current transform block, configured to store prediction residual coefficients for pixel positions in the current transform block, read the stored prediction residual coefficients and send them to an inverse transform circuit; and further configured to receive inverse quantization results for pixel positions in the current transform block from an inverse quantization circuit and write the results into the memory cells; the inverse transform circuit, configured to perform inverse transform processing on the prediction residual coefficients sent by the data storage circuit to obtain corresponding inverse transform results; the inverse quantization circuit, configured to perform inverse quantization processing on the inverse transform results sent by the inverse transform circuit to obtain corresponding inverse quantization results.

In the device for video decoding provided in the embodiments of the present disclosure, the inverse transform circuit and the inverse quantization circuit cyclically share the data storage circuit, and there is no need to additionally set up a storage circuit for the inverse transform circuit specifically for storing the predicted residual coefficients for the pixel positions in the current transform block to be processed. Therefore, the storage area of the data storage circuit can be saved, which is beneficial to saving the occupied area of the device for video decoding.

To make the above objectives, features, and advantages in the embodiments of the present disclosure more apparent and easier to understand, specific embodiments of the present disclosure are described in detail below with reference to the accompanying drawings.

FIG. 1 shows a schematic structural diagram of an embodiment of the device for video decoding according to the present disclosure. Referring to FIG. 1, a device 10 for video decoding includes a data storage circuit 110, an inverse transform circuit 120, an inverse quantization circuit 130, a gating control circuit 140, and a data gating circuit 150.

The data storage circuit 110 includes a plurality of memory cells corresponding one-to-one to pixel positions in a current transform block to be processed. Each of the memory cells is used to store prediction residual coefficients for pixel positions in the current transform block.

The data storage circuit 110 and the data gating circuit 150 are coupled to each other, so that the data storage circuit 110 is coupled to the inverse transform circuit 120 and the inverse quantization circuit 130 through the data gating circuit 150.

After storing the prediction residual coefficients for pixel positions in the current transform block, the data storage circuit 110 may also read the stored prediction residual coefficients and send them to the inverse transform circuit 120.

Specifically, the data storage circuit 110 may receive a read request signal from the inverse transform circuit 120 and, in response to the read request, read the prediction residual coefficients for corresponding pixel positions in the current transform block from the corresponding memory cells and send them to the inverse transform circuit 120, thereby providing a basis for the inverse transform circuit 120 to subsequently perform inverse transform processing on the prediction residual coefficients for the pixel positions in the current transform block.

The data storage circuit 110 may also receive inverse quantization results for the pixel positions in the current transform block from the inverse quantization circuit 130 and write them into the memory cells.

Specifically, after sending the read prediction residual coefficients for the corresponding pixel positions in the current transform block to the inverse transform circuit 120, the data storage circuit 110 may receive a write request signal from the inverse quantization circuit 130 and, in response to the write request signal, obtain the inverse quantization results for the pixel positions in the current transform block and write them into the corresponding memory cells.

From the above description, it can be seen that each memory cell in the memory cell array first stores the prediction residual coefficient for the corresponding pixel position in the current transform block, and after the prediction residual coefficient for the corresponding pixel position in the current transform block is read, the memory cell originally used to store the prediction residual coefficient for the corresponding pixel position in the current transform block can then store the inverse quantization result for the corresponding pixel position in the current transform block, so that the data storage circuit 110 can be shared by the inverse transform circuit 120 and the inverse quantization circuit 130, without the need to set up an additional storage circuit for the inverse transform circuit 120 to store the prediction residual coefficient for each pixel position in the current transform block, thereby reducing the storage area of the data storage circuit, thereby helping to save the area of the device for video decoding.

In some embodiments, the data storage circuit 110 comprises a single-port memory. In other words, the input port and output port of the data storage circuit 110 are the same port.

The single-port memory of the data storage circuit 110 further reduces the area of the device for video decoding compared to dual-port memory.

In some embodiments, the data storage circuit may also comprise a dual-port memory.

In some embodiments, the current transform block refers to a brick to be processed. A brick may represent a rectangular area of a coding tree unit (CTU) row within a tile in a picture. A picture refers to a unit representing an image in a specific time period, and a sub-picture/slice/tile is a unit that constitutes a portion of a picture. A sub-picture/slice/tile may include one or more coding tree units (CTUs). A picture may be composed of one or more tile groups. A tile group may include one or more tiles. Tiles may be partitioned into multiple bricks, each brick consisting of one or more CTU rows within the tile. Tiles that are not partitioned into multiple bricks can also be referred to as bricks.

Pixel positions are the basic units that make up a brick. The size of a brick may be expressed as the number of pixel positions it contains. Specifically, the size of a brick may be referred to interchangeably as “M*N” and “M times N” in terms of vertical and horizontal dimensions. For example, a 32*16 brick means that it has 32 pixel positions in the vertical direction (y=32) and 16 pixel positions in the horizontal direction (x=16). Furthermore, the brick may have the same number of pixel positions in the horizontal direction as in the vertical direction, that is, M and N may be the same positive integer.

For example, if the size of the current transform block is M*N, the current transform block includes M*N pixel positions, wherein the current transform block has M pixel positions in the horizontal direction and N pixel positions in the vertical direction.

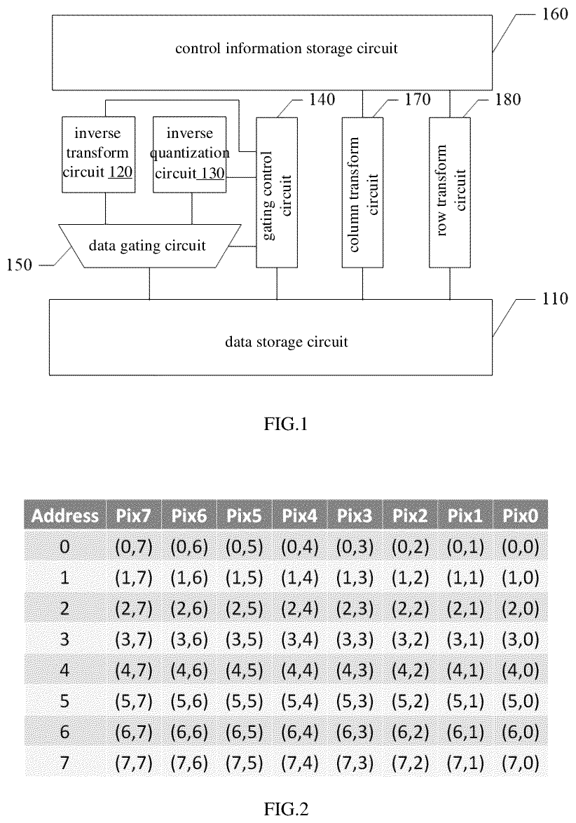

Taking the current transform block as an 8*8 brick and the data storage circuit 10 including 8*8 memory units as an example, FIG. 2 shows a schematic diagram of the storage locations of the prediction residual coefficients for pixel positions in the current 8*8 transform block within the 8*8 memory cells. With reference to FIG. 2, pix0˜pix7 are used to represent column addresses of the data storage circuit 110, which respectively correspond to a column of pixel positions of the current transformation block, that is, the column direction (X direction) of the 8*8 current transformation block, and are respectively used to store the prediction residual coefficients for the pixel positions of the corresponding columns in the 8*8 current transformation block; Address 0˜Address 7 are used to represent the row address of the data storage circuit 110, which respectively correspond to a row of pixel positions of the current transformation block, and are used to store the prediction residual coefficients of the pixel positions of the corresponding row in the 8*8 current transformation block.

In some embodiments, the memory cells are static random-access memory (SRAM) cells. SRAM cells retain their internally stored data without requiring a refresh circuit, resulting in high performance.

For example, the data storage circuit 110 comprises an address decoder, a memory cell array including the plurality of memory cells, input/output (I/O) data circuits, column I/O circuits, and control circuits. The specific structure of the data storage circuit 110 can be referenced to that of existing data storage circuit s and will not be further described here.

In some embodiments, the data storage circuit comprises a single-port data memory. Accordingly, the inverse transform circuit 120 is coupled to the data gating circuit 150, thereby achieving coupling with the data storage circuit 110 through the data gating circuit 150. When the inverse transform circuit 120 is coupled to the data storage circuit 110 through the data gating circuit 150, after the prediction residual coefficients for the pixel positions in the current transform block are stored in the data storage circuit 110, the inverse transform circuit 120 may send a corresponding read request signal to the data storage circuit 110, so that when the data storage circuit 110 receives the corresponding read request signal, it obtains the prediction residual coefficients for the corresponding pixel positions in the current transform block from the corresponding memory unit according to the received read request signal and sends the obtained data to the inverse transform circuit 120, thereby enabling the inverse transform circuit 120 to obtain the prediction residual coefficients for the corresponding pixel positions in the current transform block.

In some embodiments, the inverse transform circuit 120 is also coupled to the inverse quantization circuit 130. Upon receiving the prediction residual coefficients for pixel positions in the current transform block, the inverse transform circuit 120 may also perform an inverse transform processing on the prediction residual coefficients for the pixel positions in the current transform block, obtain an inverse transform result, and transmit the result to the inverse quantization circuit 130. This provides a basis for the inverse quantization circuit 130 to subsequently perform inverse quantization processing on the inverse transform result for the pixel positions in the current transform block.

The inverse transform circuit 120 may perform an inverse block-based delta pulse code modulation (BDPCM) transform processing on the prediction residual coefficients for the pixel positions in the current transform block in either a horizontal or longitudinal mode, obtain an inverse BDPCM transform result, and transmit the result to the inverse quantization circuit 130.

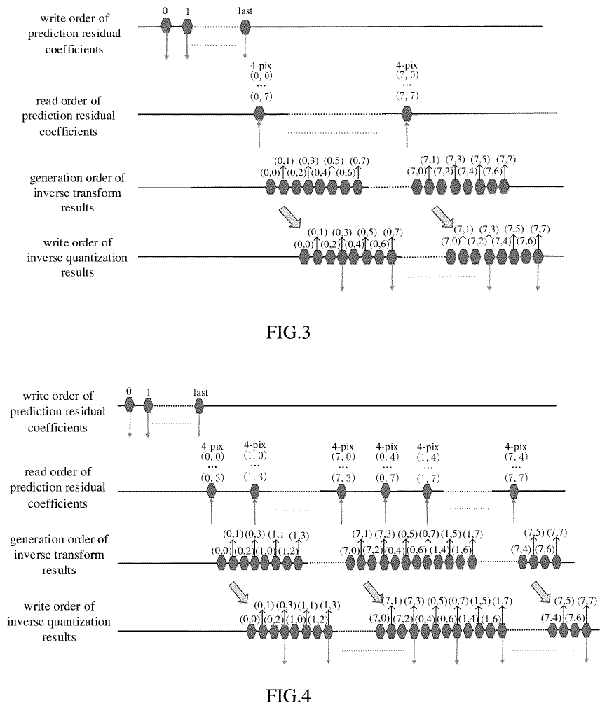

With reference to FIG. 2 and FIG. 3, the step of performing an inverse BDPCM transform processing on the received prediction residual coefficients for the pixel positions in the current transform block in a longitudinal mode includes:

In the initial consecutive four clock cycles, the inverse transform circuit 120 reads the prediction residual coefficients r(0,0), r(0,1), r(0,2), and r(0,3) for the first four pixel positions Pix0, Pix1, Pix2, and Pix3 located in the first row of the 8*8 current transform block from the Address 0 of the data storage circuit 110 at one time in the first clock cycle of the initial consecutive four clock cycles, and sequentially accumulates the prediction residual coefficients r(0,0), r(0,1), r(0,2), and r(0,3) for the first four pixel positions Pix0, Pix1, Pix2, and Pix3 located in the first row of the current transform block during the initial four clock cycles to obtain inverse BDPCM transform results q(0,0), q(0,1), q(0,2), and q(0,3) for the prediction residual coefficients r(0,0), r(0,1), r(0,2), and r(0,3) for the first four pixel positions Pix0, Pix1, Pix2, and Pix3 located in the first row of the current transform block;
In the second consecutive four clock cycles, the inverse transform circuit 120 reads the prediction residual coefficients r(1,0), r(1,1), r(1,2), and r(1,3) for the first four pixel positions Pix0, Pix1, Pix2, and Pix3 located in the second row of the 8*8 current transform block from the Address 1 of the data storage circuit 110 at one time in the first clock cycle of the second consecutive four clock cycles, and sequentially accumulates the prediction residual coefficients r(1,0), r(1,1), r(1,2), and r(1,3) for the first four pixel positions Pix0, Pix1, Pix2, and Pix3 located in the second row of the current transform block during the second consecutive four clock cycles to obtain inverse BDPCM transform results q(1,0), q(1,1), q(1,2), and q(1,3) for the first four pixel positions Pix0, Pix1, Pix2, and Pix3 located in the second row of the current transform block;
In the third consecutive four clock cycles, the inverse transform circuit 120 reads the prediction residual coefficients r(2,0), r(2,1), r(2,2), and r(2,3) for the first four pixel positions Pix0, Pix1, Pix2, and Pix3 located in the third row of the 8*8 current transform block from the Address 2 of the data storage circuit 110 at one time in the first clock cycle of the third consecutive four clock cycles, and sequentially accumulates the prediction residual coefficients r(2,0), r(2,1), r(2,2), and r(2,3) for the first four pixel positions Pix0, Pix1, Pix2, and Pix3 located in the third row of the current transform block during the third four clock cycles to obtain inverse BDPCM transform results q(2,0), q(2,1), q(2,2), and q(2,3) for the first four pixel positions Pix0, Pix1, Pix2, and Pix3 located in the third row of the current transform block;
By analogy, in the sixteenth consecutive four clock cycles, the inverse transform circuit 120 reads the prediction residual coefficients r(7,4), r(7,5), r(7,6), and r(7,7) for the last four pixel positions Pix4, Pix5, Pix6, and Pix7 located in the eighth row of the 8*8 current transform block from the Address 7 of the data storage circuit at one time in the first clock cycle of the sixteenth consecutive four clock cycles, and sequentially accumulates the prediction residual coefficients r(7,4), r(7,5), r(7,6), and r(7,7) for the last four pixel positions Pix4, Pix5, Pix6, and Pix7 located in the eighth row of the current transform block during the sixteenth consecutive four clock cycles to obtain the inverse BDPCM transform results q(7,4), q(7,5), q(7,6), and q(7,7) for the prediction residual coefficients r(7,4), r(7,5), r(7,6), and r(7,7) for the last four pixel positions Pix4, Pix5, Pix6, and Pix7 located in the eighth row of the current transform block.

In some embodiments, if the longitudinal mode is used to perform inverse BDPCM transform processing on the received prediction residual coefficients for the pixel positions in the current transform block, the inverse transform circuit 120 calculates the inverse BDPCM transform result for each pixel position in the current transform block using the following formula:

$$q ( i , j ) = \{ \begin{matrix}r ( i , j ) + 0 & i = 0 \\ r ( i , j ) + q ( i - 1 , j ) & i = 1 - 7\end{matrix} \} \qquad ( 1 )$$

Please continue to refer to FIG. 3. When the inverse transform circuit 120 adopts the longitudinal mode to perform inverse BDPCM transform processing on the received prediction residual coefficients for the pixel positions in the current transformation block, the inverse transform circuit 120 generates the inverse transform results for the pixel positions in the current transform block in the order of q(0,0), q(0,1), q(0,2), q(0,3), q(1,0), q(1,1), q(1,2), q(1,3), q(2,0), q(2,1), q(2,2), q(2,3), . . . , q(6,4), q(6,5), q(6,6), q(6,7), q(7,4), q(7,5), q(7,6), q(7,7).

With reference to FIG. 2 and FIG. 4, the step of performing an inverse BDPCM transform processing on the received prediction residual coefficients for the pixel positions in the current transform block in a horizontal mode includes:
In the initial consecutive eight clock cycles, the inverse transform circuit 120 reads the prediction residual coefficients r(0,0), r(0,1), r(0,2), r(0,3), r(0,4), r(0,5), r(0,6), and r(0,7) for the eight pixel positions Pix0, Pix1, Pix2, Pix3, Pix4, Pix5, Pix6, and Pix7 located in the first row of the 8*8 current transform block from the Address 0 of the data storage circuit at one time in the first clock cycle of the initial consecutive eight clock cycles, and sequentially accumulates the prediction residual coefficients r(0,0), r(0,1), r(0,2), r(0,3), r(0,4), r(0,5), r(0,6), and r(0,7) for the eight pixel positions Pix0, Pix1, Pix2, Pix3, Pix4, Pix5, Pix6, and Pix7 located in the first row of the 8*8 current transform block to obtain inverse BDPCM transform results q(0,0), q(0,1), q(0,2), q(0,3), q(0,4), q(0,5), q(0,6), and q(0,7) for the eight pixel positions Pix0, Pix1, Pix2, Pix3, Pix4, Pix5, Pix6, and Pix7 located in the first row of the current transform block;
In the second consecutive eight clock cycles, the inverse transform circuit 120 reads the prediction residual coefficients r(1,0), r(1,1), r(1,2), r(1,3), r(1,4), r(1,5), r(1,6), and r(1,7) for the eight pixel positions Pix0, Pix1, Pix2, Pix3, Pix4, Pix5, Pix6, and Pix7 located in the second row of the 8*8 current transform block from the Address 1 of the data storage circuit at one time in the first clock cycle of the second consecutive eight clock cycles, and sequentially accumulates the prediction residual coefficients r(1,0), r(1,1), r(1,2), r(1,3), r(1,4), r(1,5), r(1,6), and r(1,7) for the eight pixel positions Pix0, Pix1, Pix2, Pix3, Pix4, Pix5, Pix6, and Pix7 located in the second row of the 8*8 current transform block to obtain inverse BDPCM transform results q(1,0), q(1,1), q(1,2), q(1,3), q(1,4), q(1,5), q(1,6), and q(1,7) for the pixel positions located in the second row of the current transform block;
In the third consecutive eight clock cycles, the inverse transform circuit 120 reads the prediction residual coefficients r(2,0), r(2,1), r(2,2), r(2,3), r(2,4), r(2,5), r(2,6), and r(2,7) for the eight pixel positions Pix0, Pix1, Pix2, Pix3, Pix4, Pix5, Pix6, and Pix7 located in the third row of the 8*8 current transform block from the Address 2 of the data storage circuit at one time in the first clock cycle of the third consecutive eight clock cycles, and sequentially accumulates the prediction residual coefficients r(2,0), r(2,1), r(2,2), r(2,3), r(2,4), r(2,5), r(2,6), and r(2,7) for the eight pixel positions Pix0, Pix1, Pix2, Pix3, Pix4, Pix5, Pix6, and Pix7 located in the third row of the 8*8 current transform block to obtain inverse BDPCM transform results q(2,0), q(2,1), q(2,2), q(2,3), q(2,4), q(2,5), q(2,6), and q(2,7) for the eight pixel positions Pix0, Pix1, Pix2, Pix3, Pix4, Pix5, Pix6, and Pix7 located in the third row of the current transform block;
By analogy, in the eighth consecutive eight clock cycles, the inverse transform circuit 120 reads the prediction residual coefficients r(7,0), r(7,1), r(7,2), r(7,3), r(7,4), r(7,5), r(7,6), and r(7,7) for the eight pixel positions Pix0, Pix1, Pix2, Pix3, Pix4, Pix5, Pix6, and Pix7 located in the eighth row of the 8*8 current transform block from the Address 7 of the data storage circuit at one time in the first clock cycle of the eighth consecutive eight clock cycles, and sequentially accumulates the prediction residual coefficients r(7,0), r(7,1), r(7,2), r(7,3), r(7,4), r(7,5), r(7,6), and r(7,7) for the eight pixel positions Pix0, Pix1, Pix2, Pix3, Pix4, Pix5, Pix6, and Pix7 located in the eighth row of the current transform block during the eighth consecutive eight clock cycles to obtain the inverse BDPCM transform results q(7,0), q(7,1), q(7,2), q(7,3), q(7,4), q(7,5), q(7,6), and q(7,7) for the eight pixel positions Pix0, Pix1, Pix2, Pix3, Pix4, Pix5, Pix6, and Pix7 located in the eighth row of the current transform block.

In some embodiments, if the horizontal mode is used to perform inverse BDPCM transform processing on the received prediction residual coefficients for the pixel positions in the current transform block, the inverse transform circuit 120 calculates the inverse BDPCM transform result for each pixel position in the current transform block using the following formula:

$$q ( i , j ) = \{ \begin{matrix}r ( i , j ) + 0 & j = 0 \\ r ( i , j ) + q ( i , j - 1 ) & j = 1 - 7\end{matrix} \} \qquad ( 2 )$$

Wherein q(i, j) represents the inverse BDPCM transform result for the prediction residual coefficient r(i, j) for pixel position (i, j).

With reference to FIG. 4. When the inverse transform circuit 120 adopts the horizontal mode to perform inverse BDPCM transform processing on the received prediction residual coefficients for the pixel positions in the current transformation block, the inverse transform circuit 120 generates the inverse transform results for the pixel positions in the current transform block in the order of q(0,0), q(0,1), q(0,2), q(0,3), q(0,4), q(0,5), q(0,6), q(0,7), q(1,0), q(1,1), q(1,2), q(1,3), q(1,4), q(1,5), q(1,6), q(1,7), . . . , q(7,0), q(7,1) [symbol] q(7,2), q(7,3), q(7,4), q(7,5), q(7,6), q(7,7).

In some embodiments, the inverse quantization circuit 130 is coupled to the inverse transform circuit 120. The inverse quantization circuit 130 may receive the inverse transform result for the pixel position in the current transform block sent by the inverse transform circuit 120, and may perform inverse quantization processing on the received inverse transform result to obtain a corresponding inverse quantization result.

With reference to FIG. 3. When the inverse transform circuit 120 adopts the horizontal mode to perform inverse BDPCM transform processing on the received prediction residual coefficients for the pixel positions in the current transform block, the inverse quantization results for the pixel positions in the current transform block generated by the inverse quantization circuit 130 are in the order of deq(0,0), deq(0,1), dep (0,2), deq(0,3), deq(0,4), deq(0,5), deq(0,6), deq(0,7), deq(1,0), deq(1,1), deq(1,2), deq(1,3), deq(1,4), deq(1,5), deq(1,6), deq(1,7), . . . , deq(7,0), deq(7,1), deq(7,2), deq(7,3), deq(7,4), deq(7,5), deq(7,6), deq(7,7).

With reference to FIG. 4. When the inverse transform circuit 120 adopts the longitudinal mode to perform inverse BDPCM transform processing on the received prediction residual coefficients for the pixel positions in the current transform block, the inverse quantization results for the pixel positions in the current transform block generated by the inverse quantization circuit 130 are in the order of deq(0,0), deq(0,1), dep (0,2), deq(0,3), deq(1,0), deq(1,1), deq(1,2), deq(1,3), deq(2,0), deq(2,1), deq(2,2), deq(2,3), . . . , deq(6,4), deq(6,5), deq(6,6), deq(6,7), deq(7,4), deq(7,5), deq(7,6), deq(7,7).

In some embodiments, the inverse quantization circuit 130 is coupled to the data gating circuit 150, thereby achieving coupling with the data storage circuit 110 through the data gating circuit 150. The inverse quantization circuit 130 can send a corresponding write request signal to the data storage circuit 110, thereby writing the inverse quantization result for the pixel position in the current transform block into the data storage circuit 110.

In some embodiments, the data storage circuit 110 comprises a single-port storage circuit. With reference to FIG. 3, accordingly, when the inverse transform circuit 120 adopts the longitudinal mode to perform inverse BDPCM transform processing on the received prediction residual coefficients for the pixel positions in the current transform block, the inverse quantization circuit 130 stores the inverse quantization results for at least four pixel positions and then writes the stored inverse quantization results for at least four pixel positions into the data storage circuit 110 at one time. This prevents the data storage circuit 110 from simultaneously receiving a read request signal from the inverse transform circuit 120 and a write request signal from the inverse quantization circuit 130, thereby preventing the write operation of the inverse transform circuit 120 from blocking the read operation of the inverse transform circuit 120.

At the same time, the inverse transform circuit 120 writes the corresponding inverse quantization results for the four pixel positions into the data storage circuit 110 at one time when the inverse quantization results for the four pixel positions are obtained through cumulative calculation each time, so that the inverse transform circuit 120 only needs to temporarily store the inverse quantization results for the first three pixel positions among the inverse quantization results for the corresponding four pixel positions, which is beneficial to further save the area of the device for video decoding.

It should be noted that the inverse quantization circuit 130 needs to transmit information about the current transform block to the post-processing circuit and store the inverse quantization results for each pixel position in the current transform block into the data storage circuit 110, so that the delay time of the write request signal output by the inverse quantization circuit 130 is not constant, which may cause the data storage circuit 110 to receive the read request signal of the inverse transform circuit 120 and the write request signal of the inverse quantization circuit 130 at the same time.

Accordingly, when the data storage circuit 110 simultaneously receives both the read request signal sent by the inverse transform circuit 120 and the write request signal sent by the inverse quantization circuit 130, the write request signal sent by the inverse quantization circuit 130 has a higher priority than the read request signal sent by the inverse transform circuit 120. In other words, when the data storage circuit 110 simultaneously receives both the read request signal sent by the inverse transform circuit 120 and the write request signal sent by the inverse quantization circuit 130, the data storage circuit 110 prioritizes processing the write request signal sent by the inverse quantization circuit 130.

In some embodiments, the gating control circuit 140 is coupled to the inverse transform circuit 120, the inverse quantization circuit 130, and the data gating circuit 150, respectively. The gating control circuit 140 may be configured to receive access requests from the inverse transform circuit 120 and the inverse quantization circuit 130, respectively. Upon receiving an access request from the inverse transform circuit 120, the gating control circuit 140 generates a gating control signal having a first logic level; upon receiving an access request from the inverse quantization circuit 130, the gating control circuit 140 generates a gating control signal having a second logic level.

In some embodiments, the access request from the inverse quantization circuit 130 has a higher priority than the access request from the inverse transform circuit 120. Accordingly, the gating control circuit 140 may also be configured to generate a gating control signal having a second logic level upon receiving both an access request from the inverse transform circuit 120 and an access request from the inverse quantization circuit 130.

In some embodiments, the first logic level comprises a logic low level, and the second logic level comprises a logic high level. In other embodiments, the first logic level may also comprise a logic high level, and the second logic level may also comprise a logic low level.

In some embodiments, a first input port of the data gating circuit 150 is coupled to the inverse transform circuit 120, a second input port of the data gating circuit 150 is coupled to the inverse quantization circuit 130, a control port of the data gating circuit 150 is coupled to the gating control circuit 140, and an output port of the data gating circuit 150 is coupled to the data storage circuit 110. The data gating circuit 150 may couple the inverse transform circuit 120 to the data storage circuit 110 upon receiving a gating control signal having a first logic level, and couple the inverse quantization circuit 130 to the data storage circuit 110 upon receiving a gating control signal having a second logic level.

In some embodiments, the device 10 for video decoding further includes a control information storage circuit 160, a column transform circuit 170, and a row transform circuit 180. The implementation of the control information storage circuit 160, the column transform circuit 170, and the row transform circuit 180 is similar to the implementation of the corresponding circuits in existing devices for video decoding and will not be further described here.

The above description of the device for video decoding in the embodiment of the present invention uses a single-port data storage circuit 110 as an example. In other embodiments, the input port and output port of the data storage circuit may be different ports. Accordingly, the device for video decoding may also not include a gating control circuit and a data gating circuit.

Please continue to refer to FIGS. 2 to 4. Taking the current block having 64 pixel positions as an example, after the residual coefficients for the 64 pixel positions in the current block are stored in the data storage circuit 110, the inverse transform circuit 120 first reads the residual coefficients for a preset number (such as 4) of pixel positions from the data storage circuit 110 at a time and performs inverse transform processing to obtain a corresponding preset number of inverse transform results; thereafter, the inverse quantization circuit 130 performs inverse quantization processing on the preset number of inverse transform results output by the inverse transform circuit 120 to obtain a preset number of inverse quantization results.

As can be seen, each time the inverse quantization circuit 130 obtains a preset number of inverse quantization results, the prediction residual coefficients for the corresponding preset number of pixel positions in the data storage circuit 110 have already been read out by the inverse transform circuit 120. Therefore, the memory cells in the data storage circuit 110 previously used to store the prediction residual coefficients for the corresponding preset number of pixel positions are now idle. Therefore, the memory cells in the data storage circuit 110 previously used to store the prediction residual coefficients for the corresponding preset number of pixel positions can be used to store the preset number of inverse quantization results output by the inverse quantization circuit 130. Therefore, the technical solution in some embodiments of the present disclosure only uses a data storage circuit with 64 memory cells to implement cyclic storage of the prediction residual coefficients and corresponding inverse quantization results for all pixel positions in the current block. Compared with the existing solution of respectively setting a data storage circuit with 64 memory cells for the inverse transform circuit 120 and the inverse quantization circuit 130, it can save half of the storage area of the data storage circuit, which is beneficial to saving the occupied area of the device for video decoding.

Correspondingly, a method for video decoding is further provided in the embodiments of the present disclosure, comprising: using a data storage circuit to store prediction residual coefficients for pixel positions in a current transform block, the data storage circuit comprising a plurality of memory cells corresponding one-to-one to the pixel positions in the current transform block; using the data storage circuit to read the stored prediction residual coefficients and send them to an inverse transform circuit; using the inverse transform circuit to perform inverse transform processing on the prediction residual coefficients sent by the data storage circuit to obtain corresponding inverse transform results; using an inverse quantization circuit to perform inverse quantization processing on the inverse transform results sent by the inverse transform circuit to obtain corresponding inverse quantization results; using the data storage circuit to write the inverse quantization results sent by the inverse quantization circuit into the memory cells.

The method for video decoding in the embodiments of the present disclosure may be performed by the aforementioned device for video decoding, or other functional circuits can be used to perform the method for video decoding in the embodiments of the present disclosure. For the device for video decoding, please refer to the detailed description in the aforementioned section and will not be repeated here.

The embodiments of the present disclosure can be implemented by various means, such as hardware, firmware, software, or a combination thereof. In a hardware configuration, the methods according to the exemplary embodiments of the present disclosure may be implemented using one or more application-specific integrated circuits (ASICs), digital signal processors (DSPs), digital signal processing devices (DSPDs), programmable logic devices (PLDs), field-programmable gate arrays (FPGAs), processors, controllers, microcontrollers, microprocessors, and the like.

In a firmware or software configuration, the embodiments of the present disclosure may be implemented in the form of circuits, procedures, functions, and the like. Software code may be stored in a memory cell and executed by a processor. The memory cell may be located internally or externally to the processor and may transmit and receive data to and from the processor via various known means.

The above description of the disclosed embodiments enables those skilled in the art to implement or use the present disclosure. Various modifications to these embodiments will be apparent to those skilled in the art, and the general principles defined herein may be implemented in other embodiments without departing from the spirit or scope of the present disclosure. Thus, the present disclosure will not be limited to the embodiments shown herein but will be accorded the widest scope consistent with the principles and novel features disclosed herein.

Although disclosed as above, the present disclosure is not limited to the foregoing description. A person skilled in the art can make various changes and modifications without departing from the spirit and the scope of the present disclosure. Thus, the scope of protection of the present disclosure should be subject to the scope defined by the claims.

1. A device for video decoding, comprising:
a data storage circuit, comprising a plurality of memory cells corresponding one-to-one to pixel positions in a current transform block, configured to store prediction residual coefficients for pixel positions in the current transform block, read the stored prediction residual coefficients and send them to an inverse transform circuit; and further configured to receive inverse quantization results for pixel positions in the current transform block from an inverse quantization circuit and write the results into the memory cells;
the inverse transform circuit, configured to perform inverse transform processing on the prediction residual coefficients sent by the data storage circuit to obtain corresponding inverse transform results;
the inverse quantization circuit, configured to perform inverse quantization processing on the inverse transform results sent by the inverse transform circuit to obtain corresponding inverse quantization results.

2. The device for video decoding according to claim 1, wherein the data storage circuit comprises a single-port memory or a dual-port memory.

3. The device for video decoding according to claim 2, wherein if the data storage circuit comprises the single-port memory, further comprises:
a gating control circuit, configured to receive an access request from the inverse transform circuit and an access request from the inverse quantization circuit, generate a gating control signal having a first logic level upon receiving the access request from the inverse transform circuit, and generate a gating control signal having a second logic level upon receiving the access request from the inverse quantization circuit;
a data gating circuit, configured to couple the inverse transform circuit to the data storage circuit upon receiving the gating control signal having the first logic level and couple the inverse quantization circuit to the data storage circuit upon receiving the gating control signal having the second logic level.

4. The device for video decoding according to claim 3, wherein the gating control circuit is further configured to generate the gating control signal having a second logic level upon simultaneously receiving the access request from the inverse transform circuit and the access request from the inverse quantization circuit, thereby causing the data gating circuit to couple the inverse quantization circuit to the data storage circuit.

5. The device for video decoding according to claim 3, wherein the first logic level comprises a logic high level and the second logic level comprises a logic low level.

6. The device for video decoding according to claim 4, wherein the first logic level comprises a logic high level and the second logic level comprises a logic low level.

7. The device for video decoding according to claim 2, wherein the data gating circuit comprises a multiplexer.

8. The device for video decoding according to claim 1, wherein the inverse transform circuit is configured to perform inverse transform processing on the received prediction residual coefficients for the pixel positions in the current transform block using a horizontal mode.

9. The device for video decoding according to claim 1, wherein the inverse transform circuit is configured to perform inverse transform processing on the received prediction residual coefficients for the pixel positions in the current transform block using a longitudinal mode.

10. The device for video decoding according to claim 1, wherein the inverse transform circuit is configured to perform inverse BDPCM transform processing on the received prediction residual coefficients to obtain inverse BDPCM transform results for the pixel positions in the current transform block; and
the inverse quantization circuit is configured to receive the inverse BDPCM transform results for the pixel positions in the current transform block; and perform inverse quantization processing on the received inverse BDPCM transform results for the pixel positions in the current transform block to obtain inverse quantization results for the pixel positions in the current transform block.

11. The device for video decoding according to claim 1, wherein the data storage circuit comprises an SRAM memory.

12. A method for video decoding, comprising:
using a data storage circuit to store prediction residual coefficients for pixel positions in a current transform block, the data storage circuit comprising a plurality of memory cells corresponding one-to-one to the pixel positions in the current transform block;
using the data storage circuit to read the stored prediction residual coefficients and send them to an inverse transform circuit;
using the inverse transform circuit to perform inverse transform processing on the prediction residual coefficients sent by the data storage circuit to obtain corresponding inverse transform results;
using an inverse quantization circuit to perform inverse quantization processing on the inverse transform results sent by the inverse transform circuit to obtain corresponding inverse quantization results;
using the data storage circuit to write the inverse quantization results sent by the inverse quantization circuit into the memory cells.
